(19) United States
(12) Patent Application Publication
(10) Pub. No.: US 2021/0197817 A1
(43) Pub. Date: Jul. 1, 2021

(54) VEHICLE CONTROL DEVICE AND VEHICLE CONTROL METHOD

(71) Applicant: HONDA MOTOR CO., LTD., Tokyo (JP)

(72) Inventors: Yoshiyuki YAMADA, WAKO-SHI (JP); Tadayoshi OKADA, WAKO-SHI (JP); Yoshikazu SATO, WAKO-SHI (JP)

(21) Appl. No.: 17/128,683

(22) Filed: Dec. 21, 2020

(30) Foreign Application Priority Data
Dec. 25, 2019 (JP) 2019-233654

(51) Int. Cl. B60W 30/16; B60W 30/165

(52) U.S. Cl. CPC B60W 30/162; B60W 2520/105; B60W 2420/42; B60W 30/165

(57) ABSTRACT

A vehicle control device includes a detection unit detecting a preceding vehicle based on an image acquired by a camera, a follow-on travel control unit that can control a user's own vehicle to travel so as to follow the preceding vehicle, and can control the user's own vehicle to travel at a predetermined speed when the preceding vehicle does not exist, and an acceleration suppression unit suppressing acceleration of the user's own vehicle for a predetermined time period if a detection accuracy for the preceding vehicle is decreased in the detection unit when the user's own vehicle is following the preceding vehicle at the predetermined speed or less. The predetermined time period is a vehicle headway time previously determined for the preceding vehicle or a time required until the user's own vehicle reaches a location where the preceding vehicle was positioned when the detection accuracy was decreased.

### CROSS-REFERENCE TO RELATED APPLICATION

This application is based upon and claims the benefit of priority from Japanese Patent Application No. 2019-233654 filed on Dec. 25, 2019, the contents of which are incorporated herein by reference.

### BACKGROUND OF THE INVENTION

### Field of the Invention

The present invention relates to a vehicle control device and a vehicle control method.

### Description of the Related Art

In Japanese Laid-Open Patent Publication No. 2001-088574, a control is disclosed for a case in which a preceding vehicle is lost during a follow-on travel control. According to Japanese Laid-Open Patent Publication No. 2001-088574, in the case that the image recognition accuracy is decreasing, the speed is increased with a gentle or moderate resume acceleration.

### SUMMARY OF THE INVENTION

However, a technology that contributes to safer traveling continues to be eagerly awaited.

The present invention has the object of providing a vehicle control device and a vehicle control method that can contribute to safer traveling.

A vehicle control device according to one aspect of the present invention comprises a detection unit configured to detect a preceding vehicle based on an image acquired by a camera, a follow-on travel control unit configured to be capable of performing a control to cause a user's own vehicle to undertake follow-on traveling in relation to the preceding vehicle detected by the detection unit, and capable of performing a control to cause the user's own vehicle to travel at a predetermined speed in a case that the preceding vehicle does not exist, and an acceleration suppression unit configured to suppress acceleration of the user's own vehicle for a predetermined time period in a case that a detection accuracy with respect to the preceding vehicle is decreased in the detection unit when the user's own vehicle is undertaking follow-on traveling in relation to the preceding vehicle at a speed of less than or equal to the predetermined speed, wherein the predetermined time period is a vehicle headway time determined for the preceding vehicle in advance, or alternatively, is a time required until the user's own vehicle reaches a location where the preceding vehicle was positioned at a point in time when the detection accuracy with respect to the preceding vehicle was decreased.

A vehicle control device according to another aspect of the present invention comprises a detection unit configured to detect a preceding vehicle based on an image acquired by a camera, a follow-on travel control unit configured to perform a control to cause a user's own vehicle to undertake follow-on traveling in relation to the preceding vehicle detected by the detection unit, a constant speed travel control unit configured to perform a control to cause the user's own vehicle to travel at a predetermined speed in a case that the preceding vehicle does not exist, and an acceleration suppression unit configured to suppress acceleration of the user's own vehicle for a predetermined time period in a case that a detection accuracy with respect to the preceding vehicle is decreased in the detection unit when the user's own vehicle is undertaking follow-on traveling in relation to the preceding vehicle at a speed of less than or equal to the predetermined speed, wherein the predetermined time period is a vehicle headway time determined for the preceding vehicle in advance, or alternatively, is a time required until the user's own vehicle reaches a location where the preceding vehicle was positioned at a point in time when the detection accuracy with respect to the preceding vehicle was decreased.

A vehicle control method according to still another aspect of the present invention comprises a detection step of detecting a preceding vehicle based on an image acquired by a camera, a follow-on travel step of performing a control to cause a user's own vehicle to undertake follow-on traveling in relation to the preceding vehicle detected by the detection unit, and an acceleration suppression step of suppressing acceleration of the user's own vehicle for a predetermined time period in a case that a detection accuracy with respect to the preceding vehicle is decreased in the detection step when the user's own vehicle is undertaking follow-on traveling in relation to the preceding vehicle at a predetermined speed or less, wherein the predetermined time period is a vehicle headway time determined for the preceding vehicle in advance, or alternatively, is a time required until the user's own vehicle reaches a location where the preceding vehicle was positioned at a point in time when the detection accuracy with respect to the preceding vehicle was decreased.

According to the present invention, it is possible to provide a vehicle control device and a vehicle control method that contribute to safer traveling.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing a vehicle equipped with a vehicle control device according to an embodiment of the present invention;

FIGS. 2A and 2B are diagrams showing an example of a case in which the detection accuracy of a detection unit is decreased;

FIGS. 3A and 3B are diagrams showing an example of a case in which the detection accuracy of the detection unit is decreased;

FIG. 4 is a flowchart showing an example of operations of the vehicle control device according to the embodiment;

FIGS. 5A, 5B, and 5C are time charts showing an example of operations of the vehicle control device according to the embodiment;

FIGS. 6A, 6B, and 6C are time charts showing an example of operations of the vehicle control device according to the embodiment;

FIGS. 7A, 7B, and 7C are time charts showing an example of operations of the vehicle control device according to the embodiment;

FIGS. 8A, 8B, and 8C are time charts showing an example of operations of the vehicle control device according to the embodiment; and

FIG. 9 is a block diagram showing a configuration of a vehicle control device according to a modification.

### DETAILED DESCRIPTION OF THE PREFERRED EMBODIMENTS

Preferred embodiments of a vehicle control device and a vehicle control method according to the present invention will be presented and described in detail below with reference to the accompanying drawings.

### EMBODIMENTS

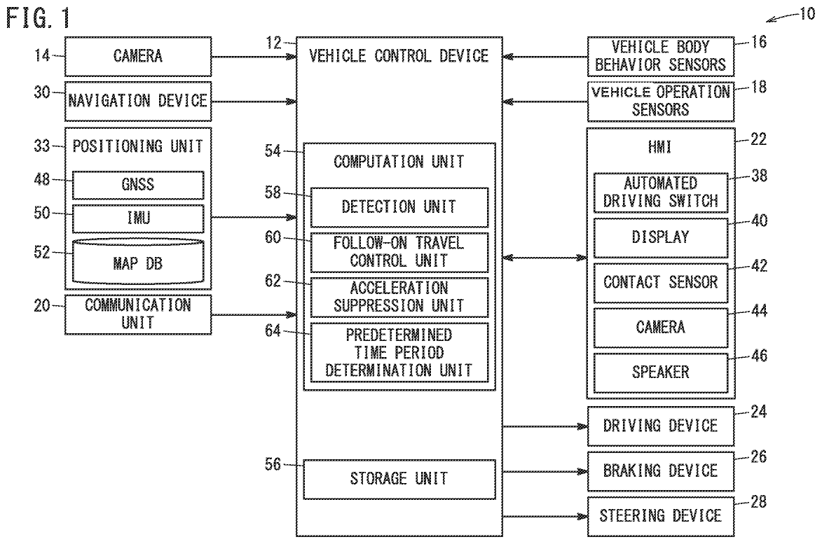

A vehicle control device and a vehicle control method according to an embodiment of the present invention will be described with reference to FIGS. 1 to 8. FIG. 1 is a block diagram showing a vehicle equipped with a vehicle control device according to the present embodiment.

A vehicle (user's own vehicle) 10 is equipped with a vehicle control device 12, namely, a vehicle control ECU (Electronic Control Unit). The vehicle 10 is further equipped with a camera 14, vehicle body behavior sensors 16, vehicle operation sensors 18, a communication unit 20, and an HMI (Human Machine Interface) 22. The vehicle 10 is further equipped with a driving device 24, a braking device 26, a steering device 28, a navigation device 30, and a positioning unit 33.

The camera 14 acquires external environmental information, namely, peripheral information around the vicinity of the vehicle 10. Images (camera information) acquired by the camera (imaging unit) 14 are supplied from the camera 14 to the vehicle control device 12. Although a single camera 14 is illustrated in FIG. 1, a plurality of cameras 14 may also be provided.

The vehicle body behavior sensors 16 acquire information, namely, vehicle body behavior information, in relation to the behavior of the vehicle 10. The vehicle body behavior sensors 16 include a non-illustrated vehicle speed sensor, non-illustrated vehicle wheel speed sensors, a non-illustrated acceleration sensor, and a non-illustrated yaw rate sensor. The vehicle speed sensor detects the speed, i.e., the vehicle speed, of the vehicle 10. Further, the vehicle speed sensor detects the direction in which the vehicle 10 is traveling. The vehicle wheel speed sensors detect the speed, i.e., the vehicle wheel speed, of the non-illustrated vehicle wheels. The acceleration sensor detects the acceleration of the vehicle 10. The term “acceleration” includes a longitudinal acceleration, a lateral acceleration, and a vertical acceleration. It should be noted that the acceleration of only a portion of the aforementioned directions may be detected by the acceleration sensor. The yaw rate sensor detects a yaw rate of the vehicle 10.

The vehicle operation sensors (driving operation sensors) 18 acquire information, namely, driving operation information, in relation to driving operations made by a user (driver). The vehicle operation sensors 18 include a non-illustrated accelerator pedal sensor, a non-illustrated brake pedal sensor, a non-illustrated steering angle sensor, and a non-illustrated steering torque sensor. The accelerator pedal sensor detects an operated amount of a non-illustrated accelerator pedal. The brake pedal sensor detects an operated amount of a non-illustrated brake pedal. The steering angle sensor detects the steering angle of a non-illustrated steering wheel. The torque sensor detects a torque applied to the steering wheel.

The communication unit 20 performs wireless communications with non-illustrated external equipment. The external equipment may include, for example, a non-illustrated external server. The communication unit 20 may be capable of being detached from the vehicle 10, or may be non-detachable with respect to the vehicle. As examples of the communication unit 20 that can be attached to and detached from the vehicle 10, there may be cited a mobile phone and a smartphone.

The HMI 22 receives an operation input made by the user (vehicle occupant), and provides various types of information to the user in a visual, audible, or tactile manner. The HMI 22 includes, for example, an automated driving switch (driving assist switch) 38, a display 40, a contact sensor 42, a camera 44, and a speaker 46.

The automated driving switch 38 is used by the user in order to instruct starting or stopping of automated driving. As an example of automated driving, there may be cited follow-on traveling in which the user's own vehicle 10 is made to travel in a manner so as to follow a preceding vehicle 70. The automated driving switch 38 includes a non-illustrated start switch and a non-illustrated stop switch. The start switch outputs a start signal to the vehicle control device 12 in accordance with an operation of the user. The stop switch outputs a stop signal to the vehicle control device 12 in accordance with an operation of the user.

The display (display unit) 40 is capable of carrying out a predetermined display. As examples of the display 40, there may be cited a liquid crystal display, an organic EL display, or the like, although the present invention is not limited to such displays. In this instance, although an exemplary case will be described in which the display 40 is a touch panel, the present invention is not limited to this feature.

The contact sensor 42 serves to detect whether or not the user (driver) is touching the steering wheel. Signals output from the contact sensor 42 are supplied to the vehicle control device 12. On the basis of signals supplied from the contact sensor 42, the vehicle control device 12 is capable of determining whether or not the user is touching the steering wheel.

The camera 44 captures images of the interior, i.e., a non-illustrated vehicle compartment interior, of the vehicle 10. The camera 44 may be disposed, for example, on a non-illustrated dashboard, or may be disposed on a non-illustrated ceiling of the vehicle 10. Further, the camera 44 may be disposed in a manner so that images are captured of only the driver, or may be disposed in a manner so that images are captured of each of the vehicle occupants. The camera 44 outputs information, and more specifically, image information, which is acquired by capturing images of the vehicle compartment interior, to the vehicle control device 12.

The speaker (notification unit) 46 serves to provide various types of information to the user by way of sound or voice. The vehicle control device 12 outputs various notifications, alarms, or the like using the speaker 46.

The driving device (driving force control system) 24 includes a non-illustrated drive ECU, and a non-illustrated drive source. By controlling the drive source, the drive ECU controls the driving force (torque) of the vehicle 10. As examples of the drive source, there may be cited an engine or a drive motor. The drive ECU is capable of controlling the driving force by controlling the drive source, based on an operation made by the user with respect to the accelerator pedal. Further, the drive ECU is capable of controlling the driving force by controlling the drive source, based on a command supplied from the vehicle control device 12. The driving force of the drive source is transmitted to the non-illustrated vehicle wheels via a non-illustrated transmission.

The braking device (braking force control system) 26 includes a non-illustrated brake ECU, and a non-illustrated brake mechanism. The brake mechanism actuates a brake member by a brake motor, a hydraulic mechanism, or the like. The brake ECU is capable of controlling the braking force by controlling the drive mechanism, based on an operation made by the user with respect to the brake pedal. Further, the brake ECU is capable of controlling the braking force by controlling the brake mechanism, based on a command supplied from the vehicle control device 12.

The steering device (steering system) 28 includes a non-illustrated steering ECU, and more specifically, an EPS (electric power steering system) ECU, and a non-illustrated steering motor. The steering ECU controls the direction of the vehicle wheels (steering wheels) by controlling the steering motor, based on an operation made by the user with respect to the steering wheel. Further, the steering ECU controls the direction of the vehicle wheels by controlling the steering motor, based on a command supplied from the vehicle control device 12. Steering may be performed by changing the torque distribution and the braking force distribution with respect to the left and right vehicle wheels.

The navigation device 30 is equipped with a non-illustrated GNSS (Global Navigation Satellite System) sensor. In addition, the navigation device 30 is further equipped with a non-illustrated computation unit and a non-illustrated storage unit. The GNSS sensor detects the current position of the vehicle 10. From a map database stored in the storage unit, the computation unit reads out map information corresponding to the current position detected by the GNSS sensor. Using the map information, the computation unit determines a target route from the current position to a destination.

The positioning unit 33 is equipped with a GNSS 48. The positioning unit 33 is further provided with an IMU (Inertial Measurement Unit) 50 and a map database (map DB) 52. The positioning unit 33 specifies the position of the vehicle 10 by appropriately using the information obtained by the GNSS 48, the information obtained by the IMU 50, and the map information stored in the map database 52.

The vehicle control device 12 is equipped with a computation unit 54 and a storage unit 56. The computation unit 54 governs the overall control of the vehicle control device 12. The computation unit 54 is constituted, for example, by a CPU (Central Processing Unit). The computation unit 54 executes the vehicle control by controlling the respective units based on programs stored in the storage unit 56.

The computation unit 54 is equipped with a detection unit 58, a predetermined time period determination unit 64, a follow-on travel control unit 60, and an acceleration suppression unit 62. The detection unit 58, the predetermined time period determination unit 64, the follow-on travel control unit 60, and the acceleration suppression unit 62 can be realized by the computation unit 54 executing a program stored in the storage unit 56.

The storage unit 56 includes a non-illustrated volatile memory, and a non-illustrated nonvolatile memory. As an example of the volatile memory, there may be cited a RAM (Random Access Memory). As an example of the nonvolatile memory, there may be cited a ROM (Read Only Memory), a flash memory, or the like. Programs, tables, maps, and the like are stored, for example, in the nonvolatile memory.

The detection unit 58 is capable of detecting the preceding vehicle 70 based on an image acquired by the camera 14. The detection accuracy of the detection unit 58 may be decreased in the following situations.

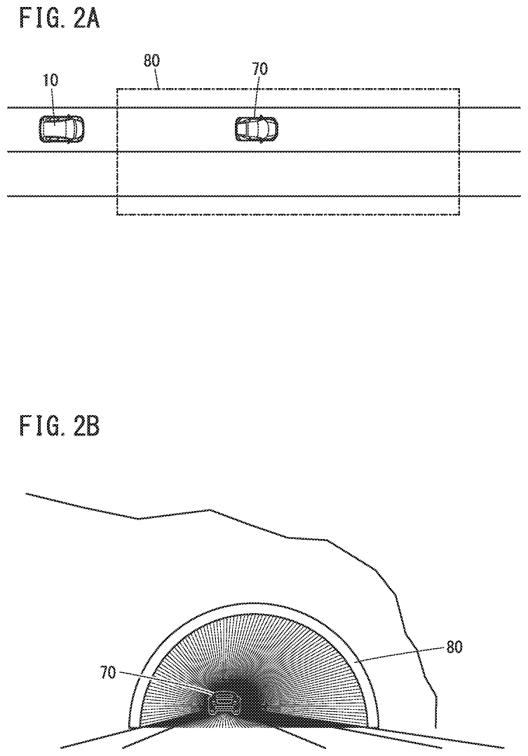

FIGS. 2A and 2B are diagrams showing an example of a case in which the detection accuracy of the detection unit 58 is decreased. In FIGS. 2A and 2B, a state is shown in which the preceding vehicle 70 has entered a tunnel 80, whereas the user's own vehicle 10 that is undertaking follow-on traveling in relation to the preceding vehicle 70 has not yet entered the tunnel 80. A positional relationship between the tunnel 80, the user's own vehicle 10, and the preceding vehicle 70 is shown in FIG. 2A. An example of an image acquired by the camera 14 provided in the user's own vehicle 10 is shown conceptually in FIG. 2B.

In the state in which the user's own vehicle 10 has not entered the tunnel 80 even though the preceding vehicle 70 has entered the tunnel 80, the exposure of the camera 14 may be set based on the surrounding environment of the user's own vehicle 10 which has not entered the tunnel 80. In this case, in the image acquired by the camera 14, the brightness of the preceding vehicle 70 which is located in the tunnel 80 may be extremely low. Since the brightness of the preceding vehicle 70 in the image is extremely low, and the brightness inside the tunnel 80 in the image is also extremely low, it is difficult for the detection unit 58 to detect the preceding vehicle 70 on the basis of such an image. Accordingly, in such a case, the detection accuracy of the detection unit 58 may be decreased.

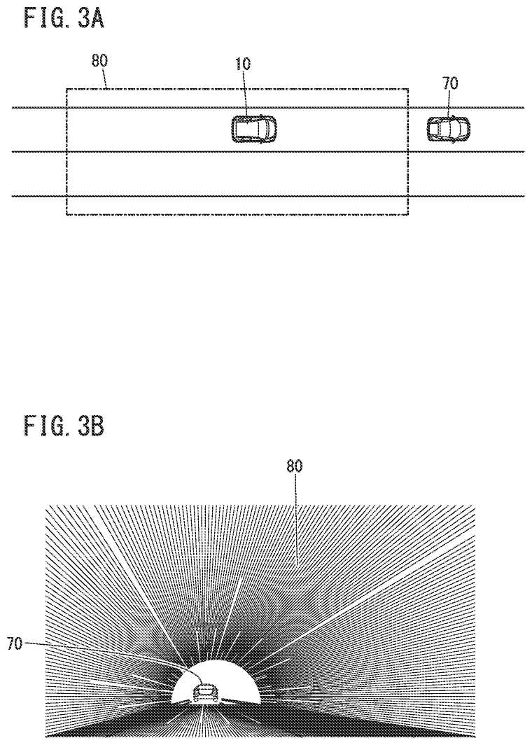

FIGS. 3A and 3B are diagrams showing an example of a case in which the detection accuracy of the detection unit 58 is decreased. In FIGS. 3A and 3B, a state is shown in which the preceding vehicle 70 has come out to the exterior of the tunnel 80, whereas the user's own vehicle 10 that is undertaking follow-on traveling in relation to the preceding vehicle 70 is positioned inside the tunnel 80. A positional relationship between the tunnel 80, the user's own vehicle 10, and the preceding vehicle 70 is shown in FIG. 3A. An example of an image acquired by the camera 14 provided in the user's own vehicle 10 is shown conceptually in FIG. 3B.

In the state in which the user's own vehicle 10 is positioned inside the tunnel 80 even though the preceding vehicle 70 has come out to the exterior of the tunnel 80, the exposure of the camera 14 may be set based on the surrounding environment of the user's own vehicle 10 which is positioned inside the tunnel 80. In this case, in the image acquired by the camera 14, the brightness of the preceding vehicle 70 which is positioned outside of the tunnel 80 may be extremely high. Since the brightness of the preceding vehicle 70 in the image is extremely high, and the brightness outside of the tunnel 80 in the image is also extremely high, it is difficult for the detection unit 58 to detect the preceding vehicle 70 on the basis of such an image. Accordingly, in such a case as well, the detection accuracy of the detection unit 58 may be decreased.

The follow-on travel control unit 60 is capable of performing a control, and more specifically, a follow-on travel control, for causing the user's own vehicle 10 to undertake follow-on traveling in relation to the preceding vehicle 70 detected by the detection unit 58. Further, the follow-on travel control unit 60 is also capable of performing a control, and more specifically, a constant speed travel control, for causing the user's own vehicle 10 to travel at a predetermined speed Vpd in the case that the preceding vehicle 70 does not exist. The predetermined speed Vpd can be set beforehand by a user or the like, however, the present invention is not limited to this feature.

The acceleration suppression unit 62 is capable of suppressing acceleration of the user's own vehicle 10 for a predetermined time period Tpd, in the case that the detection accuracy with respect to the preceding vehicle 70 is decreased in the detection unit 58, when the user's own vehicle 10 is made to undertake follow-on traveling in relation to the preceding vehicle 70 at a speed of less than or equal to the predetermined speed Vpd. In such a case, suppression of the acceleration of the user's own vehicle 10 for the predetermined time period Tpd is for the purpose of contributing to safer traveling.

The predetermined time period determination unit 64 is capable of determining the predetermined time period Tpd, and more specifically, an acceleration suppression time period, which is a time period during which acceleration of the user's own vehicle 10 is suppressed by the acceleration suppression unit 62. The predetermined time period Tpd, for example, is a vehicle headway time determined for the preceding vehicle 70 in advance. The vehicle headway time, for example, is on the order of three seconds, although the present invention is not limited to this feature.

The predetermined time period Tpd is not necessarily limited to the description given above. The time required until the user's own vehicle 10 reaches a location where the preceding vehicle 70 was positioned at the point in time when the detection accuracy with respect to the preceding vehicle 70 was decreased may be set as the predetermined time period Tpd. In the case that the time required until the user's own vehicle 10 reaches the location where the preceding vehicle 70 was positioned at the point in time when the detection accuracy with respect to the preceding vehicle 70 was decreased is set as the predetermined time period Tpd, the predetermined time period determination unit 64 is capable of calculating the predetermined time period Tpd, for example, in the following manner. More specifically, for example, based on an image acquired immediately before the detection accuracy with respect to the preceding vehicle 70 was decreased, the predetermined time period determination unit 64 calculates the distance between the location where the preceding vehicle 70 was positioned at the point in time when the detection accuracy with respect to the preceding vehicle 70 was decreased, and the location where the user's own vehicle 10 is currently positioned. Based on the distance which is calculated in this manner and the speed of the user's own vehicle 10, the predetermined time period determination unit 64 calculates the time required until the user's own vehicle 10 reaches the location where the preceding vehicle 70 was positioned at the point in time when the detection accuracy with respect to the preceding vehicle 70 was decreased.

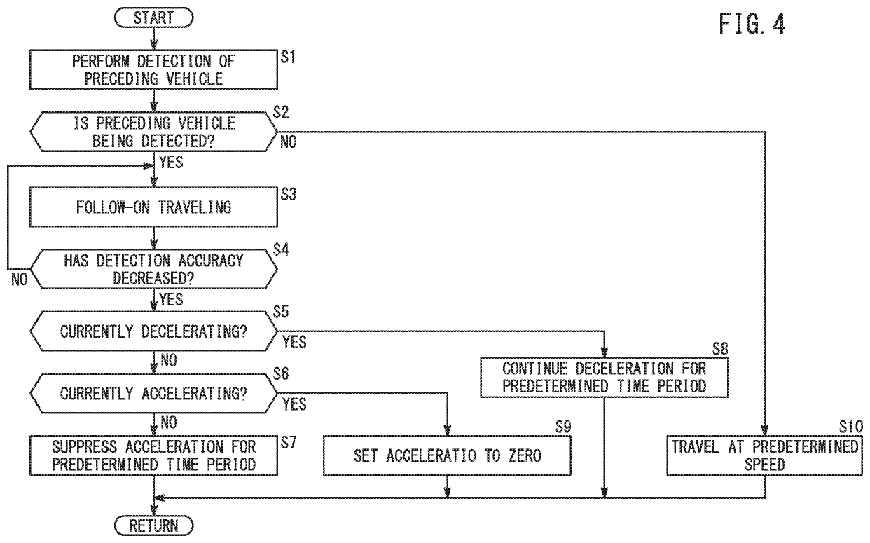

An example of operations of the vehicle control device 12 according to the present embodiment will be described with reference to FIG. 4. FIG. 4 is a flowchart showing an example of operations of the vehicle control device 12 according to the present embodiment. In FIG. 4, an example is shown of operations when the user's own vehicle 10 is made to undertake follow-on traveling in relation to the preceding vehicle 70.

In step S1, the detection unit 58 carries out detection of the preceding vehicle 70 based on an image acquired by the camera 14. Thereafter, the process transitions to step S2.

In step S2, the follow-on travel control unit 60 determines whether or not the preceding vehicle 70 is being detected by the detection unit 58. In the case that the preceding vehicle 70 is being detected by the detection unit 58 (YES in step S2), the process transitions to step S3. In the case that the preceding vehicle 70 is not being detected by the detection unit 58 (NO in step S2), the process transitions to step S10.

In step S3, the follow-on travel control unit 60 performs a control to cause the user's own vehicle 10 to undertake follow-on traveling in relation to the preceding vehicle 70. Thereafter, the process transitions to step S4.

In step S4, the acceleration suppression unit 62 determines whether or not the detection accuracy with respect to the preceding vehicle 70 has decreased in the detection unit 58. Specifically, a decrease in the detection accuracy with respect to the preceding vehicle 70 in the detection unit 58 corresponds, for example, to a situation in which the preceding vehicle 70 which has been detected by the detection unit 58 suddenly has become incapable of being detected by the detection unit 58. In the case that the detection accuracy with respect to the preceding vehicle 70 is not decreased in the detection unit 58 (NO in step S4), the processes after step S3 are repeated. In the case that the detection accuracy with respect to the preceding vehicle 70 is decreased in the detection unit 58 (YES in step S4), the process transitions to step S5.

In step S5, the acceleration suppression unit 62 determines whether or not the user's own vehicle 10 is currently decelerating. Whether or not the user's own vehicle 10 is currently decelerating can be determined, for example, based on a change in the speed of the user's own vehicle 10. In the case that the user's own vehicle 10 is currently decelerating (YES in step S5), the process transitions to step S8. In the case that the user's own vehicle 10 is not currently decelerating (NO in step S5), the process transitions to step S6.

In step S6, the acceleration suppression unit 62 determines whether or not the user's own vehicle 10 is currently accelerating. Whether or not the user's own vehicle 10 is currently accelerating can be determined, for example, based on a change in the speed of the user's own vehicle 10. In the case that the user's own vehicle 10 is currently accelerating (YES in step S6), the process transitions to step S9. In the case that the user's own vehicle 10 is not currently accelerating (NO in step S6), the process transitions to step S7.

In step S7, the acceleration suppression unit 62 suppresses the acceleration of the user's own vehicle 10 for the predetermined time period Tpd.

In step S8, the acceleration suppression unit 62 continues the deceleration of the user's own vehicle 10 for the predetermined time period Tpd.

In step S9, the acceleration suppression unit 62 sets the acceleration of the user's own vehicle 10 to zero.

In step S10, the follow-on travel control unit 60 causes the user's own vehicle 10 to travel at the predetermined speed Vpd. Upon doing so, the process shown in FIG. 4 is brought to an end.

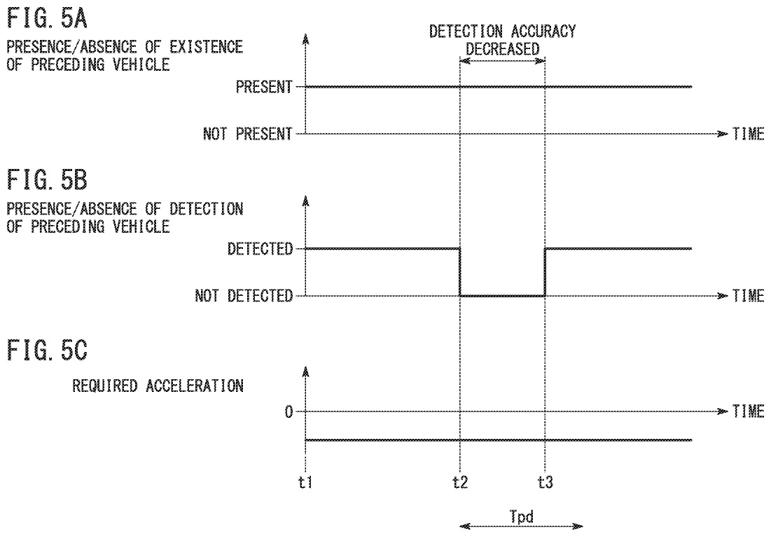

FIGS. 5A to 5C are time charts showing an example of operations of the vehicle control device according to the present embodiment. In FIGS. 5A to 5C, an example is shown in which the detection accuracy with respect to the preceding vehicle 70 is decreased in the detection unit 58 during deceleration of the user's own vehicle 10, and thereafter, the detection accuracy with respect to the preceding vehicle 70 is recovered in the detection unit 58. FIG. 5A shows the presence or absence of the preceding vehicle 70. FIG. 5B shows whether or not the preceding vehicle 70 is detected by the detection unit 58. FIG. 5C shows a required acceleration for the user's own vehicle 10. It should be noted that a negative required acceleration implies a required deceleration. The required acceleration is an acceleration required by the vehicle control device 12 of the vehicle 10. The required deceleration is a deceleration required by the vehicle control device 12 of the vehicle 10.

At timing t1, the preceding vehicle 70 exists in front of the user's own vehicle 10. Further, at timing t1, the detection unit 58 is detecting the preceding vehicle 70 based on the image acquired by the camera 14. At timing t1, the required deceleration for the user's own vehicle 10 is set at a certain required deceleration.

At timing t2, a state occurs in which the preceding vehicle 70 is not detected by the detection unit 58.

At timing t3, a state occurs in which the preceding vehicle 70 is detected by the detection unit 58. The period from timing t2 to timing t3 is a period during which the detection accuracy with respect to the preceding vehicle 70 is decreased in the detection unit 58, or stated otherwise, a period during which the preceding vehicle 70 is lost. In the example shown in FIGS. 5A to 5C, the period from timing t2 to timing t3 is less than the predetermined time period Tpd. In the example shown in FIGS. 5A to 5C, in the period from timing t2 to timing t3, the required deceleration for the user's own vehicle 10 is maintained.

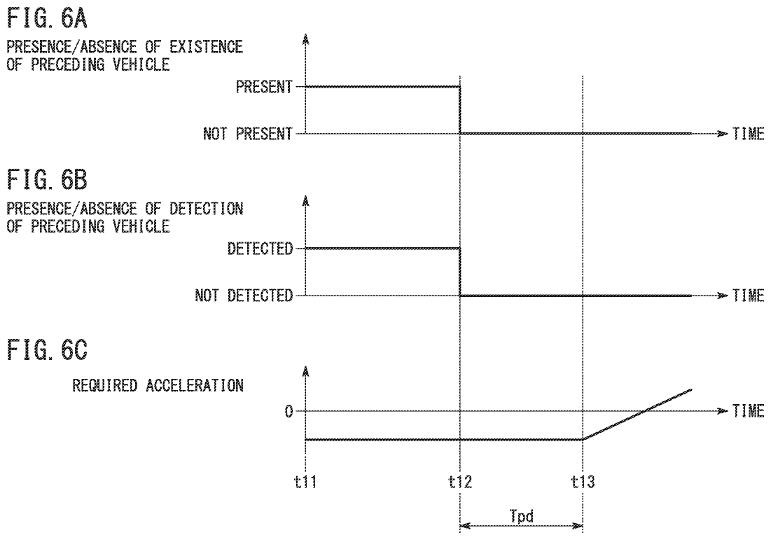

FIGS. 6A to 6C are time charts showing an example of operations of the vehicle control device according to the present embodiment. In FIGS. 6A to 6C, an example is shown of a case in which the preceding vehicle 70 has ceased to exist during deceleration of the user's own vehicle 10. FIG. 6A shows the presence or absence of the preceding vehicle 70. FIG. 6B shows whether or not the preceding vehicle 70 is detected by the detection unit 58. FIG. 6C shows a required acceleration for the user's own vehicle 10.

At timing t11, the preceding vehicle 70 exists in front of the user's own vehicle 10. Further, at timing t11, the detection unit 58 is detecting the preceding vehicle 70 based on the image acquired by the camera 14. At timing t11, the required deceleration for the user's own vehicle 10 is set at a certain required deceleration.

At timing t12, a state occurs in which the preceding vehicle 70 no longer exists. Further, at timing t12, a state occurs in which the preceding vehicle 70 is not detected by the detection unit 58.

Timing t13 is a timing occurring after the predetermined time period Tpd has elapsed from timing t12. As noted previously, in the case that the detection accuracy with respect to the preceding vehicle 70 is decreased while the user's own vehicle 10 is decelerating, the deceleration of the user's own vehicle 10 is continued for the predetermined time period Tpd. Accordingly, during the period from timing t12 to timing t13, the required deceleration for the user's own vehicle 10 is maintained.

Deceleration of the user's own vehicle 10 is continued for the predetermined time period Tpd, and after the predetermined time Tpd has elapsed, the user's own vehicle 10 can be accelerated. As noted previously, in the case that the preceding vehicle 70 does not exist, the follow-on travel control unit 60 causes the user's own vehicle 10 to travel at the predetermined speed Vpd. Accordingly, at timing t13 and thereafter, the required acceleration is increased in order to cause the user's own vehicle 10 to travel at the predetermined speed Vpd.

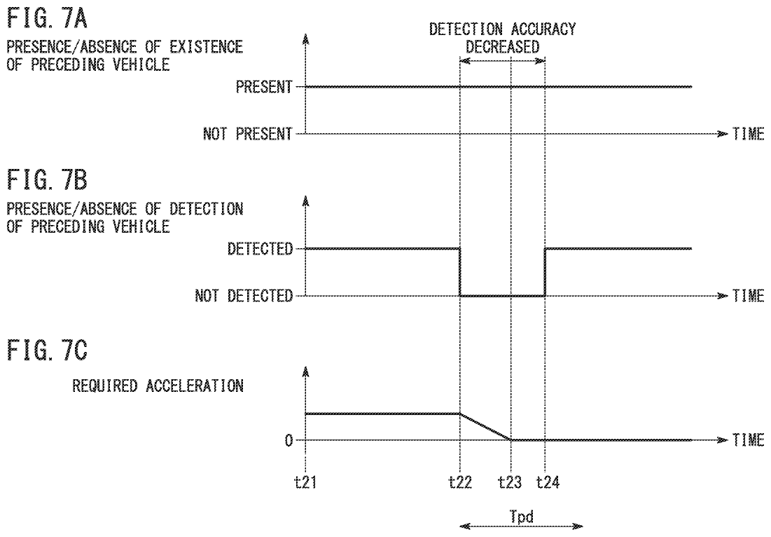

FIGS. 7A to 7C are time charts showing an example of operations of the vehicle control device according to the present embodiment. In FIGS. 7A to 7C, an example is shown in which the detection accuracy with respect to the preceding vehicle 70 is decreased in the detection unit 58 during acceleration of the user's own vehicle 10, and thereafter, the detection accuracy with respect to the preceding vehicle 70 is recovered in the detection unit 58. FIG. 7A shows the presence or absence of the preceding vehicle 70. FIG. 7B shows whether or not the preceding vehicle 70 is detected by the detection unit 58. FIG. 7C shows a required acceleration for the user's own vehicle 10.

At timing t21, the preceding vehicle 70 exists in front of the user's own vehicle 10. Further, at timing t21, the detection unit 58 is detecting the preceding vehicle 70 based on the image acquired by the camera 14. At timing t21, the required acceleration for the user's own vehicle 10 is set to a certain required acceleration.

At timing t22, a state occurs in which the preceding vehicle 70 is not detected by the detection unit 58. As noted previously, in the case that the detection accuracy with respect to the preceding vehicle 70 is decreased when the user's own vehicle 10 is accelerating, the acceleration suppression unit 62 sets the required acceleration to zero. Therefore, at timing t22 and thereafter, the required acceleration decreases, and at timing t23, the required acceleration becomes zero. After the required acceleration has arrived at zero, the state in which the required acceleration is zero is maintained.

At timing t24, a state occurs in which the preceding vehicle 70 is detected by the detection unit 58. The period from timing t22 to timing t24 is a period during which the detection accuracy with respect to the preceding vehicle 70 is decreased in the detection unit 58. In the example shown in FIGS. 7A to 7C, the period from timing t22 to timing t24 is less than the predetermined time period Tpd.

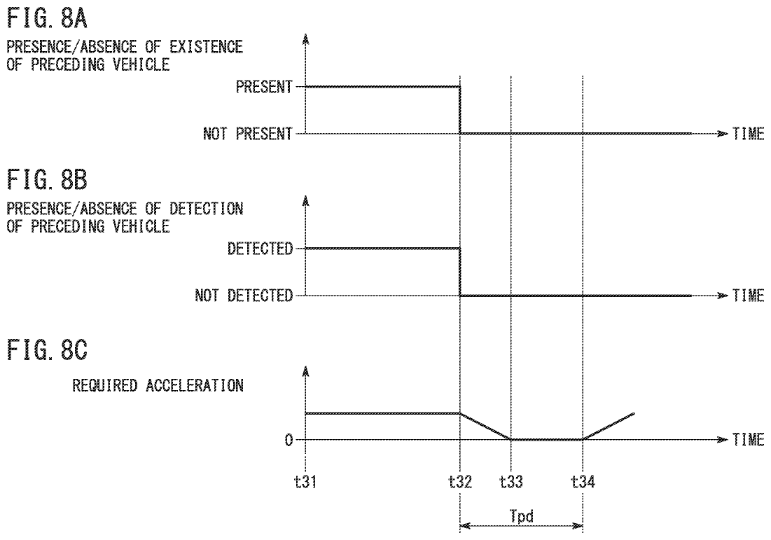

FIGS. 8A to 8C are time charts showing an example of operations of the vehicle control device according to the present embodiment. In FIGS. 8A to 8C, an example is shown of a case in which the preceding vehicle 70 has ceased to exist during deceleration of the user's own vehicle 10. FIG. 8A shows the presence or absence of the preceding vehicle 70. FIG. 8B shows whether or not the preceding vehicle 70 is detected by the detection unit 58. FIG. 8C shows a required acceleration for the user's own vehicle 10.

At timing t31, the preceding vehicle 70 exists in front of the user's own vehicle 10. Further, at timing t31, the detection unit 58 is detecting the preceding vehicle 70 based on the image acquired by the camera 14. At timing t31, the required acceleration for the user's own vehicle 10 is set to a certain required acceleration.

At timing t32, a state occurs in which the preceding vehicle 70 no longer exists. Further, at timing t32, a state occurs in which the preceding vehicle 70 is not detected by the detection unit 58. As noted previously, in the case that the detection accuracy with respect to the preceding vehicle 70 is decreased when the user's own vehicle 10 is accelerating, the acceleration suppression unit 62 sets the required acceleration to zero. Therefore, at timing t32 and thereafter, the required acceleration decreases, and at timing t33, the required acceleration becomes zero. After the required acceleration has arrived at zero, the state in which the required acceleration is zero is maintained.

Deceleration of the user's own vehicle 10 is continued for the predetermined time period Tpd, and after the predetermined time Tpd has elapsed, the user's own vehicle 10 can be accelerated. As noted previously, in the case that the preceding vehicle 70 does not exist, the follow-on travel control unit 60 causes the user's own vehicle 10 to travel at the predetermined speed Vpd. Accordingly, at timing t34 and thereafter, the required acceleration is increased in order to cause the user's own vehicle 10 to travel at the predetermined speed Vpd.

In the foregoing manner, according to the present embodiment, in the case that the detection accuracy with respect to the preceding vehicle 70 is decreased in the detection unit 58, the acceleration of the user's own vehicle 10 is suppressed for the predetermined time period Tpd. Therefore, according to the present embodiment, it is possible to contribute to safe traveling.

### (Modification)

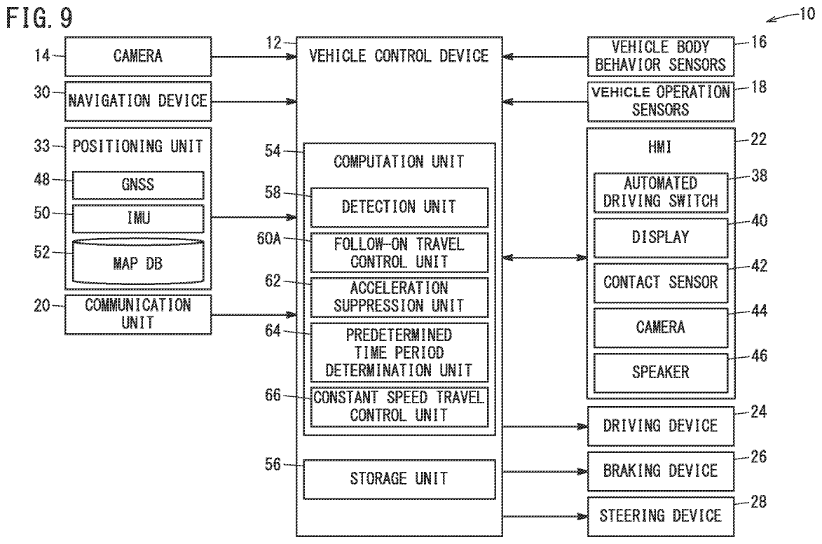

A vehicle control device and a vehicle control method according to a modification of the present embodiment will be described with reference to FIG. 9. FIG. 9 is a block diagram showing a configuration of a vehicle equipped with a vehicle control device according to the modification.

As shown in FIG. 9, according to the present modification, the computation unit 54 is equipped with a constant speed travel control unit 66 separately from a follow-on travel control unit 60A. The follow-on travel control unit 60A is capable of performing a control, and more specifically, a follow-on travel control, for causing the user's own vehicle 10 to undertake follow-on traveling in relation to the preceding vehicle 70 detected by the detection unit 58. The constant speed travel control unit 66 is capable of performing a control, and more specifically, a constant speed travel control, for causing the user's own vehicle 10 to travel at the predetermined speed Vpd in the case that the preceding vehicle 70 does not exist. In the vehicle control device 12 according to the embodiment, which was described with reference to FIG. 1, the follow-on travel control unit 60 performs not only the follow-on travel control but also the constant speed travel control. In contrast thereto, according to the present modification, the follow-on travel control is carried out by the follow-on travel control unit 60A, whereas the constant speed travel control is carried out by the constant speed travel control unit 66.

According to the present modification, the travel control for the user's own vehicle 10 is performed by the follow-on travel control unit 60A, until the predetermined time period Tpd has elapsed from the point in time when the preceding vehicle 70 ceased to be detected by the detection unit 58. However, acceleration of the user's own vehicle 10 is suppressed by the acceleration suppression unit 62, until the predetermined time period Tpd has elapsed from the point in time when the preceding vehicle 70 ceased to be detected by the detection unit 58.

In the case that the preceding vehicle 70 is not detected by the detection unit 58 at the stage at which the predetermined time period Tpd has elapsed from the point in time when the preceding vehicle 70 ceased to be detected by the detection unit 58, a situation is brought about in which traveling of the user's own vehicle 10 is controlled by the constant speed travel control unit 66.

In the foregoing manner, the follow-on travel control may be performed by the follow-on travel control unit 60A, and the constant speed travel control may be performed by the constant speed travel control unit 66. In the present modification as well, acceleration of the user's own vehicle 10 is suppressed by the acceleration suppression unit 62, until the predetermined time period Tpd has elapsed from the point in time when the preceding vehicle 70 ceased to be detected by the detection unit 58. Therefore, in the present modification as well, it is possible to contribute to safe traveling.

### Modified Embodiments

Although preferred embodiments of the present invention have been described above, the present invention is not limited to the above-described embodiment, and various modifications can be made thereto without departing from the essence and gist of the present invention.

For example, a description has been given for a case in which, in the case that the detection accuracy with respect to the preceding vehicle 70 is decreased in the detection unit 58 (YES in step S4), the process transitions to step S5 irrespective of the position of the user's own vehicle 10. However, the present invention is not necessarily limited to this feature. The process may also transition to step S5, in the case that the detection accuracy with respect to the preceding vehicle 70 is decreased in the detection unit 58 (YES in step S4), and at the same time, the user's own vehicle 10 is positioned in the vicinity of an entrance or exit of the tunnel 80. In the case that the detection accuracy with respect to the preceding vehicle 70 is decreased in the detection unit 58 in a state in which the user's own vehicle 10 is not positioned in the vicinity of an entrance or an exit of the tunnel 80, it may be determined that the preceding vehicle 70 no longer exists.

Summarizing the embodiments described above, the following features and advantages are realized.

The vehicle control device (12) includes the detection unit (58) that detects the preceding vehicle (70) based on the image acquired by the camera (14), the follow-on travel control unit (60) that is capable of performing the control to cause the user's own vehicle (10) to undertake follow-on traveling in relation to the preceding vehicle detected by the detection unit, and is capable of performing a control to cause the user's own vehicle to travel at the predetermined speed (Vpd) in the case that the preceding vehicle does not exist, and the acceleration suppression unit (62) that suppresses acceleration of the user's own vehicle for the predetermined time period (Tpd), in the case that a detection accuracy with respect to the preceding vehicle is decreased in the detection unit when the user's own vehicle is undertaking follow-on traveling in relation to the preceding vehicle at a speed of less than or equal to the predetermined speed, wherein the predetermined time period is a vehicle headway time determined for the preceding vehicle in advance, or alternatively, is a time required until the user's own vehicle reaches a location where the preceding vehicle was positioned at a point in time when the detection accuracy with respect to the preceding vehicle was decreased. In accordance with such a configuration, when the detection accuracy with respect to the preceding vehicle is decreased in the detection unit, since the acceleration of the user's own vehicle is suppressed for the predetermined time period, such a feature can contribute to safe traveling.

In the case that the detection accuracy with respect to the preceding vehicle is decreased when the user's own vehicle is accelerating, the acceleration suppression unit may continue the deceleration of the user's own vehicle for the predetermined time period. In accordance with such a configuration, when the detection accuracy with respect to the preceding vehicle is decreased in the detection unit, since the deceleration of the user's own vehicle is continued for the predetermined time period, such a feature can contribute to safe traveling.

In the case that the detection accuracy with respect to the preceding vehicle is decreased when the user's own vehicle is accelerating, the acceleration suppression unit may set the acceleration of the user's own vehicle to zero. In accordance with such a configuration, when the detection accuracy with respect to the preceding vehicle is decreased in the detection unit, since the acceleration of the user's own vehicle is reduced to zero, such a feature can contribute to safe traveling.

The vehicle control device comprises the detection unit that detects the preceding vehicle based on the image acquired by the camera, the follow-on travel control unit that performs a control to cause the user's own vehicle to undertake follow-on traveling in relation to the preceding vehicle detected by the detection unit, the constant speed travel control unit (66) that performs a control to cause the user's own vehicle to travel at the predetermined speed in the case that the preceding vehicle does not exist, and the acceleration suppression unit which suppresses the acceleration of the user's own vehicle for the predetermined time period, in the case that the detection accuracy with respect to the preceding vehicle is decreased in the detection unit when the user's own vehicle is undertaking follow-on traveling in relation to the preceding vehicle at a speed of less than or equal to the predetermined speed, wherein the predetermined time period is a vehicle headway time determined for the preceding vehicle in advance, or alternatively, is a time required until the user's own vehicle reaches a location where the preceding vehicle was positioned at a point in time when the detection accuracy with respect to the preceding vehicle was decreased.

The vehicle control method comprises the detection step (step S1) of detecting the preceding vehicle based on the image acquired by the camera, the follow-on travel step (step S3) of performing a control to cause the user's own vehicle to undertake follow-on traveling in relation to the preceding vehicle detected by the detection unit, and the acceleration suppression step (step S7) of suppressing the acceleration of the user's own vehicle for the predetermined time period, in the case that the detection accuracy with respect to the preceding vehicle is decreased in the detection step when the user's own vehicle is undertaking follow-on traveling in relation to the preceding vehicle at a speed of less than or equal to the predetermined speed, wherein the predetermined time period is a vehicle headway time determined for the preceding vehicle in advance, or alternatively, is a time required until the user's own vehicle reaches a location where the preceding vehicle was positioned at a point in time when the detection accuracy with respect to the preceding vehicle was decreased.

What is claimed is:

1. A vehicle control device comprising one or more processors, wherein the one or more processors:
detect a preceding vehicle based on an image acquired by a camera;
perform a control to cause a user's own vehicle to undertake follow-on traveling in relation to the detected preceding vehicle, and perform a control to cause the user's own vehicle to travel at a predetermined speed in a case that the preceding vehicle does not exist; and
suppress acceleration of the user's own vehicle for a predetermined time period in a case that a detection accuracy with respect to the preceding vehicle is decreased in the detection when the user's own vehicle is undertaking follow-on traveling in relation to the preceding vehicle at a speed of less than or equal to the predetermined speed, and
wherein the predetermined time period is a vehicle headway time determined for the preceding vehicle in advance, or alternatively, is a time required until the user's own vehicle reaches a location where the preceding vehicle was positioned at a point in time when the detection accuracy with respect to the preceding vehicle was decreased.

2. The vehicle control device according to claim 1, wherein, in a case that the detection accuracy with respect to the preceding vehicle is decreased when the user's own vehicle is decelerating, the one or more processors continue deceleration of the user's own vehicle for the predetermined time period.

3. The vehicle control device according to claim 1, wherein, in a case that the detection accuracy with respect to the preceding vehicle is decreased when the user's own vehicle is accelerating, the one or more processors set an acceleration of the user's own vehicle to zero.

4. A vehicle control device comprising one or more processors, wherein the one or more processors:
detect a preceding vehicle based on an image acquired by a camera;
perform a control to cause a user's own vehicle to undertake follow-on traveling in relation to the detected preceding vehicle;
perform a control to cause the user's own vehicle to travel at a predetermined speed in a case that the preceding vehicle does not exist, and
suppress acceleration of the user's own vehicle for a predetermined time period in a case that a detection accuracy with respect to the preceding vehicle is decreased in the detection when the user's own vehicle is undertaking follow-on traveling in relation to the preceding vehicle at a speed of less than or equal to the predetermined speed, and
wherein the predetermined time period is a vehicle headway time determined for the preceding vehicle in advance, or alternatively, is a time required until the user's own vehicle reaches a location where the preceding vehicle was positioned at a point in time when the detection accuracy with respect to the preceding vehicle was decreased.

5. A vehicle control method comprising:
detecting a preceding vehicle based on an image acquired by a camera;
performing a control to cause a user's own vehicle to undertake follow-on traveling in relation to the detected preceding vehicle; and
suppressing acceleration of the user's own vehicle for a predetermined time period in a case that a detection accuracy with respect to the preceding vehicle is decreased in the detection when the user's own vehicle is undertaking follow-on traveling in relation to the preceding vehicle at a predetermined speed or less,
wherein the predetermined time period is a vehicle headway time determined for the preceding vehicle in advance, or alternatively, is a time required until the user's own vehicle reaches a location where the preceding vehicle was positioned at a point in time when the detection accuracy with respect to the preceding vehicle was decreased.
